(19) United States
(12) Patent Application Publication
(10) Pub. No.: US 2021/0277859 A1
(43) Pub. Date: Sep. 9, 2021

(54) INJECTOR FOR VEHICLE

(71) Applicant: HYUNDAI KEFICO CORPORATION, Gunpo (KR)

(72) Inventors: Hyung Ik Kim, Gunpo (KR); Dong Hyun Kim, Gunpo (KR)

(21) Appl. No.: 17/189,715

(22) Filed: Mar. 2, 2021

(30) Foreign Application Priority Data
Mar. 9, 2020 (KR) 10-2020-0029001

(51) Int. Cl. F02M 61/10; F02M 55/02; F02M 51/06

(52) U.S. Cl. CPC F02M 61/10; F02M 51/061; F02M 55/025

(57) ABSTRACT

An injector of a vehicle includes a valve needle conducting linear reciprocal movement together with an amateur movably mounted on an outer circumferential surface of the valve needle, as a power source of an electromagnetic generator is applied or cut off inside a valve housing, a valve body provided on an end of an engine side of the valve needle and conducting the linear reciprocal movement together with the valve needle to open and close an injection hole, and a shock absorption structure provided between an end of the valve needle and the valve body to support the valve body toward the injection hole to fundamentally prevent bouncing of the valve needle, thereby preventing dribbling or additional injection of undesired fuel toward the engine.

### CROSS-REFERENCE(S) TO RELATED APPLICATION(S)

This application claims under 35 U.S.C. § 119 the benefit of Korean Patent Application No. 10-2020-0029001 filed on Mar. 9, 2020, the entire contents of which are incorporated herein by reference.

### BACKGROUND

### (a) Technical Field

The present disclosure relates to an injector, more particularly, to an injector that can prevent bouncing of a valve needle, thus preventing dribbling or additional injection of undesired fuel toward an engine.

### (b) Description of the Related Art

Generally, in recent years, operation of a fuel injector for directly injecting fuel to a combustion chamber of an engine is mostly controlled electronically, and a representative example of such an injector having an opening and closing valve structure is illustrated in FIG. 1 (RELATED ART).

As illustrated in FIG. 1, an injector 10 includes an opening and closing valve bundle 20 including a valve needle 13 for directly opening and closing an injection hole 12, an electromagnet coil 21 for pulling the valve needle 13 when the injection hole 12 is opened, an amateur 22 for pulling the valve needle 13 by receiving the attractive force of the electromagnetic coil 21, a pressing spring 28 for elastically pressing the valve needle 13 to the injection hole 12, and the like.

The opening and closing valve bundle 20 includes a stop ring 26 and a stop sleeve 24 integrally provided on the valve needle 13, and further includes the pressing spring 28, a buffer spring 25, the amateur 22, and a spring holder 27 for supporting the buffer spring 25 on the opposite side of the stop sleeve 24 in order to elastically support the amateur 22 by the buffer spring 25.

In the case of a conventional injector 10, in the normal case where the injection operation is not performed, as illustrated in FIGS. 1 and 2, the valve needle 13 is pressed toward the injection hole 12 together with the stop ring 26 pressed by the elastic force of the pressing spring 28 to close the injection hole 12 by a valve ball 14.

However, when the injector 10 is operated for the high-pressure injection of the fuel, the electromagnetic coil 21 of the opening and closing valve bundle 20 is excited. Therefore, the amateur 22 is pulled by the magnetic force of the coil 21 to compress the buffer spring 25 to the stop sleeve 24 and to rise upward to contact the stop ring 26.

The amateur 22 still pulled by the electromagnetic coil 21 even after contacting the stop ring 26 now rises while compressing the pressing spring 28 through the stop ring 26, as illustrated in FIG. 3, and therefore, the valve needle 13 also rises together to open the injection hole 12 to inject the high-pressure fuel charged inside a housing 11 into a combustion chamber.

Then, when the injection of the injector 10 is completed, the electromagnet coil 21 is conversely demagnetized to remove the attractive force of the electromagnetic coil 21 pulling the amateur 22, such that the valve needle 13 returns to the normal state illustrated in FIG. 2 by the restoring forces of the pressing spring 28 and the buffer spring 25 and the gravity of the opening and closing valve bundle 20 to close the injection hole 12.

However, there is a problem in that the valve needle 13 is recoiled by the elastic repulsive force when the valve ball 14 and a valve seat around the injection hole 12 are in contact with each other or the high injection pressure of the injection hole 12 to rise upward again, as illustrated in FIG. 4.

This is often referred to as “bouncing” of the valve needle, and there is a problem in that there occurs dribbling or additional injection of undesired fuel to the combustion chamber by the bouncing.

Particularly, as the valve needle and the valve ball made of a metallic material are provided in a structure of being integrated by welding, the elastic repulsive force is inevitably generated while the valve needle and the valve ball are in contact with the valve sheet made of a metallic material, and further, the elastic repulsive force is larger in proportion with the rigidity, such that there is a problem in that the elastic repulsive force is high, thereby increasing the bouncing effect.

Further, the valve ball is abraded by the contact between the metals, thereby lowering durability performance, the manufacturing cost is increased by applying the coating for improving the abrasion resistance of the conventional valve ball, and a quality problem such as runout failure may occur in the welding bonding portion between the valve needle and the valve ball, such that there is a problem in that reliability of the product may be reduced.

Further, as dribbling is caused by the bouncing, it is difficult to inject an accurate amount of fuel into the combustion chamber of the engine, such that there is a problem in that combustion performance and exhaust performance may be deteriorated.

### SUMMARY

The present disclosure provides an injector, which may prevent bouncing of a valve needle, thereby preventing dribbling or additional injection of undesired fuel toward an engine, and addressing exhaust regulations by improving the combustion performance and the exhaust performance.

Further, another object of the present disclosure is to provide an injector, which may be capable of absorbing a shock between a valve needle and a valve body to absorb an elastic repulsive force, and improve durability and abrasion resistance even if a coating applied to a conventional valve body is omitted, thereby reducing a unit price of the component.

Further, still another object of the present disclosure is to provide an injector, which may reduce the number of processes and solve a manufacturing quality problem such as runout failure due to welding as the welding process of a valve needle and a valve body is omitted.

The object of the present disclosure is not limited thereto, and other objects not mentioned may be clearly understood by those skilled in the art from the following description.

An injector for supplying the fuel introduced from a fuel rail to an engine may include: a valve needle conducting linear reciprocal movement together with an amateur movably mounted on an outer circumferential surface of the valve needle, as a power source of an electromagnetic generator is applied or cut off inside a valve housing, a valve body provided on an end of an engine side of the valve needle and conducting the linear reciprocal movement together with the valve needle to open and close an injection hole, and a shock absorption structure provided between an end of the valve needle and the valve body to support the valve body toward the injection hole.

The shock absorption structure may include: a shock absorption spring connected between the end of the engine side of the valve needle and the valve body to support the valve body toward the injection hole.

Further, the shock absorption structure may further include: an accommodation groove formed to be longitudinally recessed on the end of the engine side of the valve needle, the accommodation groove having the shock absorption spring inserted therein, and guiding movement of the valve body.

Further, the injector may further include: a stopper fixed to a location for facing a fuel rail side of the amateur on the valve needle, a positioning fixed to a location for facing the engine side of the amateur on the valve needle, a pressing spring installed in the valve housing to press the valve needle toward the injection hole, and a buffer spring provided between the stopper and the amateur on the valve needle to press the amateur toward the positioning.

At this time, when the injection hole is closed, the shock absorption spring may be coupled to cover the end of the engine side of the valve housing, and may absorb a primary shock amount generated by a collision of the valve body with a valve seat formed with the injection hole and absorb a secondary shock amount generated by a collision of the amateur with the positioning.

Further, the valve needle may include: a crimp part formed to protrude from an inner surface of the accommodation groove to seat the valve body and preventing the valve body from being separated from the accommodation groove.

Further, the valve body may include: a seating surface formed in a planar shape perpendicular to a movement direction of the valve needle to seat the shock absorption spring and a location fixing part formed to protrude from a central portion of the seating surface and inserted into the shock absorption spring.

According to the present disclosure, as the shock absorption structure may be provided between the valve needle and the valve body, it is possible to fundamentally prevent the bouncing of the valve needle to prevent dribbling or additional injection of undesired fuel toward the engine, and to improve combustion performance and exhaust performance, thereby addressing exhaust regulations.

Further, the shock absorption structure absorbs the primary shock amount and the secondary shock amount caused when the injection hole is closed, and it is possible to save the unit price of the component as the durability and the abrasion resistance are improved even if the coating applied to the conventional valve body is omitted.

Further, it is possible to omit the welding process of the conventional valve needle and valve body, thereby reducing the number of processes and addressing the manufacturing quality problem such as runout failure due to the welding.

### BRIEF DESCRIPTION OF THE DRAWINGS

The accompanying drawings, which are included to provide a further understanding of the disclosure and are incorporated in and constitute a part of this specification, illustrate embodiments of the disclosure and together with the description serve to explain the principles of the disclosure. In the drawings:

FIG. 1 (RELATED ART) is a partially enlarged cross-sectional diagram schematically illustrating a conventional injector.

FIGS. 2 to 4 (RELATED ART) are schematic diagrams illustrating the valve opening and closing operation of an injector illustrated in FIG. 1.

FIG. 5 is a partially enlarged longitudinal cross-sectional diagram of the injector according to an exemplary embodiment of the present disclosure.

FIG. 6 is a partially enlarged diagram of FIG. 5.

FIG. 7 is an exploded perspective diagram illustrating a needle bar, a shock absorption spring, and a valve body of the injector according to the exemplary embodiment of the present disclosure.

FIGS. 8 to 11 are schematic diagrams illustrating the closing operation of an injection hole of the injector according to the exemplary embodiment of the present disclosure.

FIG. 12 is a partially enlarged longitudinal cross-sectional diagram of an injector according to another exemplary embodiment of the present disclosure.

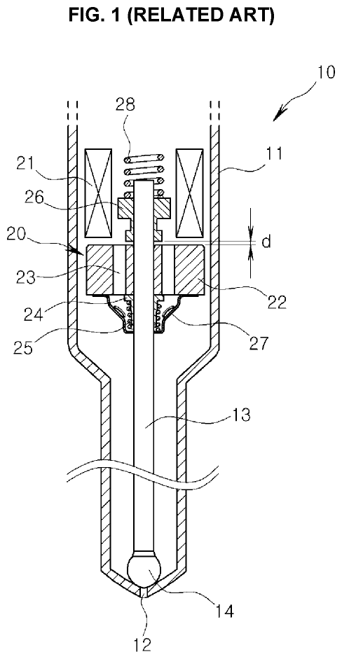

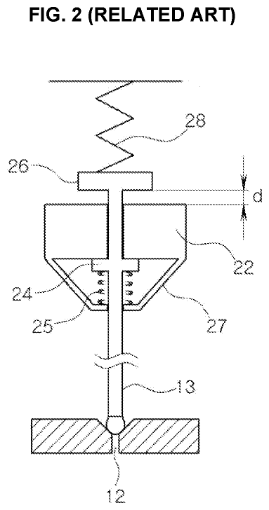

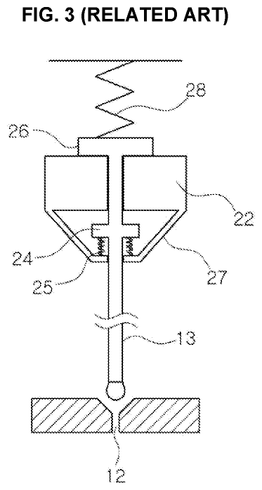

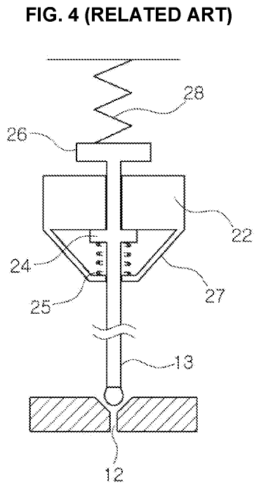

### DESCRIPTION OF SPECIFIC EMBODIMENTS

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Hereinafter, some exemplary embodiments of the present disclosure will be described in detail with reference to the exemplary drawings. In adding the reference numerals to the components in each drawing, it should be noted that the same components have the same reference numerals if possible, even if they are illustrated in other drawings. Further, in describing the present disclosure, if it is determined that the detailed description of the related known components or functions may obscure the gist of the present disclosure, the detailed description thereof will be omitted.

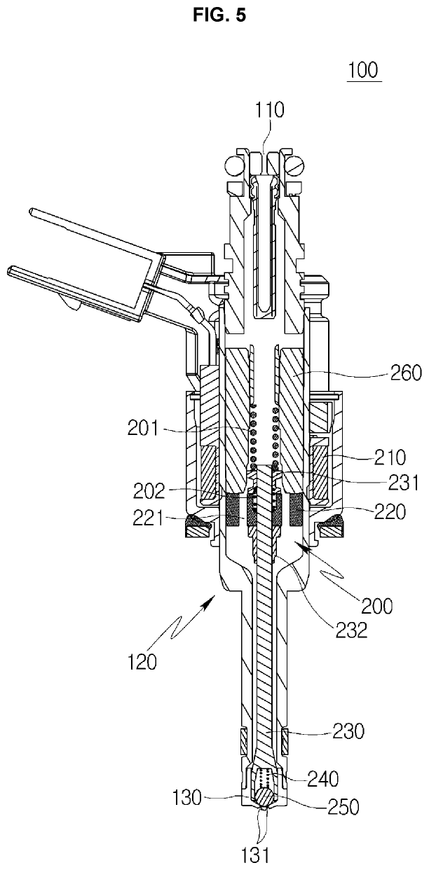

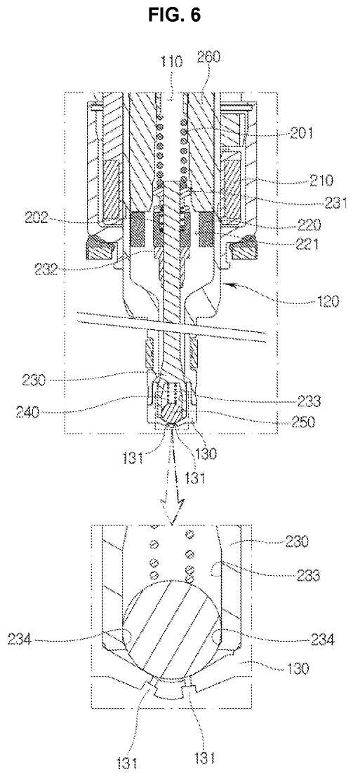

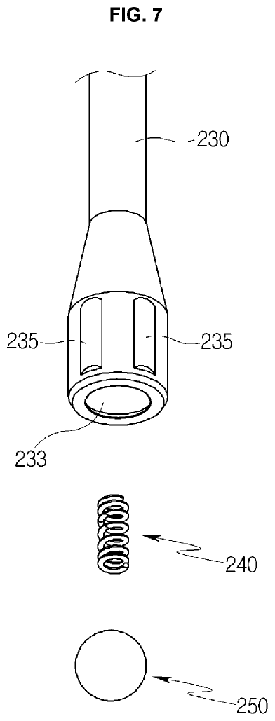

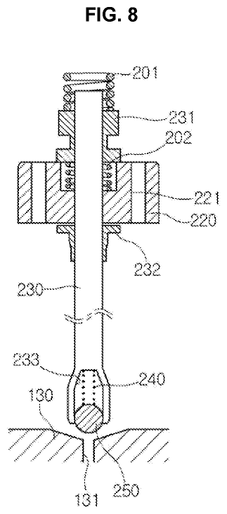

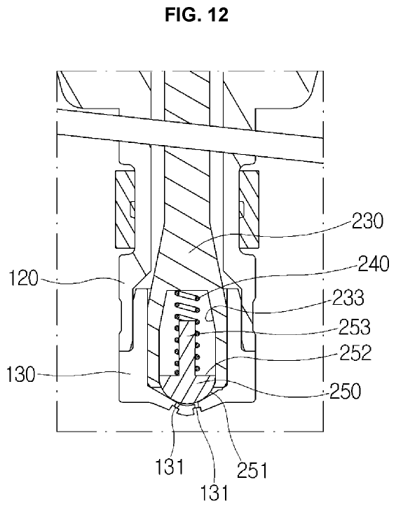

FIG. 5 is a partially enlarged longitudinal cross-sectional diagram of an injector according to an exemplary embodiment of the present disclosure, FIG. 6 is a partially enlarged diagram of FIG. 5, FIG. 7 is an exploded perspective diagram illustrating a needle bar, a shock absorption spring, and a valve body of the injector according to the exemplary embodiment of the present disclosure, FIGS. 8 to 11 are schematic diagrams illustrating the closing operation of an injection hole of the injector according to the exemplary embodiment of the present disclosure, and FIG. 12 is a partially enlarged longitudinal cross-sectional diagram of an injector according to another exemplary embodiment of the present disclosure.

As provided herein, an injector 100 according to an exemplary embodiment of the present disclosure is characterized by including a valve needle 230 conducting linear reciprocal movement together with an amateur 220 movably mounted on an outer circumferential surface of the valve needle 230 as the power source of an electromagnetic generator 210 is applied or cut off inside a valve housing 120, a valve body 250 provided on an end of an engine side of the valve needle 230 and conducting linear reciprocal movement together with the valve needle 230 to open and close an injection hole 131, and a shock absorption structure provided between an end of the valve needle 230 and the valve body 250 to support the valve body 250 toward the injection hole 131.

Further, in the detailed description of the present disclosure to be described later, one direction will be described by designating the engine side of the injector 100 as a downward direction, and designating a fuel rail side of the injector 100 as an upward direction for the convenience of the description unless otherwise mentioned.

The injector 100 according to the present disclosure is provided to supply the fuel introduced from the fuel rail to the engine, have an axial one side end coupled to the fuel rail, have an axial other side end coupled to the engine, and inject the fuel introduced from the fuel rail to the engine.

Further, the injector 100 has the fuel introduced therein through a fuel suction port 110 provided on the upper side of the valve housing 120. Further, the injector 100 has an opening and closing valve bundle 200 inside the valve housing 120 for injecting the introduced fuel into the engine side at high pressure through the injection hole 131 of the valve seat 130.

The opening and closing valve bundle 200 is configured to include a magnetic core 260, the electromagnetic generator 210, the valve needle 230 provided with a stopper 231 and a positioning 232, the amateur 220, a pressing spring 201, a buffer spring 202, the valve body 250, and the like.

The magnetic core 260 is formed in a hollow shape and inserted into and fixed to the valve housing 120, and has the pressing spring 201, for pressing the valve needle 230 downward, inserted into the inside thereof. Further, the magnetic core 260 has the upper end of the inserted pressing spring 201 supported by the inside thereof and configures a magnetic circuit by the electromagnetic generator 210.

The valve needle 230 is a portion of directly opening and closing the injection hole 131 inside the valve housing 120, and disposed to extend in a vertical and longitudinal direction inside the valve housing 120 forming the appearance of the injector 100. Further, the valve body 250 is provided on the lower end of the valve needle 230 through the shock absorption structure and seated on the valve seat 130.

Further, the valve needle 230 receives the magnetic force through the amateur 220 to move upward when the electromagnetic generator 210 is excited according to the application of the power source, and moves downward by gravity and the pressing spring 201 when the electromagnetic generator 210 is demagnetized according to the cut-off of the power source.

The valve seat 130 is inserted into a lower end of the valve housing 120 and coupled to the valve housing 120. Further, the valve seat 130 has a part of a lower end of the valve needle 230 inserted into the inside thereof, and has the injection hole 131 opened and closed by the valve body 250 provided on the lower end thereof.

Further, the lower end of the valve needle 230 inserted into the valve seat 130 is provided with a support part 235 formed to protrude in a projection form lengthwise formed in the longitudinal direction on the outer circumferential surface thereof.

The support part 235 has a protruding end which is in contact with an inner circumferential surface of the valve seat 130 and the protruding end is formed in the curved surface in order to reduce the friction with the valve seat 130.

A plurality of support parts 235 are provided on the outer circumferential surface of the valve needle 230 in a circumferential direction to be spaced apart from each other by regular intervals and the fuel flows between the support parts 235.

That is, since the support part 235 is in contact with the inner circumferential surface of the valve seat 130, the fuel flows to the injection hole 131 between the support parts 235.

The electromagnetic generator 210 is a driving mechanism for allowing the valve needle 230 to vertically conduct the reciprocal motion while repeating the exciting and the demagnetizing as the power source is applied or cut off, and disposed at a location for surrounding the amateur 220 outside the valve housing 120.

The electromagnetic generator 210 pulls and moves the amateur 220 and the valve needle 230 upward and opens the injection hole 131 when the power source is applied. On the other hand, the electromagnetic generator 210 allows the valve needle 230 to return to the original location by the elastic force of the pressing spring 201 to close the injection hole 131 when the power source is cut off.

The amateur 220 is a device configured to transfer the magnetic force of the electromagnetic generator 210 to the valve needle 230, and preferably is made of the cylindrical metallic material. Further, the amateur 220 has a fuel passage 221 formed to axially penetrate the valve housing 120 so as not to disturb the flow of the fuel within the valve housing 120.

Further, the amateur 220 is mounted coaxially with the valve needle 230 to be fitted into the valve needle 230 and located between the stopper 231 and the positioning 232. Therefore, the amateur 220 vertically moves along the outer circumferential surface of the valve needle 230 between the stopper 231 and the positioning 232, when moving upward by the electromagnetic generator 210 or when supported downward by the buffer spring 202.

Further, the valve needle 230 may have the stopper 231 and the positioning 232 integrally provided, and for example, the stopper 231 and the positioning 232 may be integrally provided on the outer circumference of the valve needle 230 through the welding, but the valve needle 230 is not limited thereto.

The stopper 231 is fixed to a location for facing the upper surface, which is the fuel rail side of the amateur 220 on the valve needle 230 and the buffer spring 202 is disposed between the stopper 231 and the amateur 220. Further, the stopper 231 has the upper end supported by the pressing spring 201 downward.

The positioning 232 is fixed to a location for facing the lower surface, which is the engine side of the amateur 220 on the valve needle 230 to restrict the axial movement amount of the amateur 220.

The pressing spring 201 is a device configured to press the valve needle 230 toward the injection hole 131 which is the lower side.

The pressing spring 201 presses the valve needle 230 toward the injection hole 131 to close the injection hole 131 through the valve needle 230.

To this end, one end of the pressing spring 201 is supported by an inner circumferential surface of the valve housing 120 or an inner circumferential surface of the magnetic core 260 and the other end of the pressing spring 201 is supported by contacting the stopper 231. Therefore, the pressing spring 201 presses the valve needle 230 toward the injection hole 131.

The buffer spring 202 is fitted into the circumference of the valve needle 230 to be guided and disposed between the stopper 231 and the amateur 220 to be provided to press the amateur 220 toward the positioning 232 at all times. Further, the buffer spring 202 is configured such that a predetermined gap is maintained between the stopper 231 and the amateur 220 in the normal case where the power source is cut off for the electromagnetic generator 210.

Further, the injector 100 has the valve needle 230 and the valve body 250 provided to be connected through the shock absorption structure, in order to reduce the bouncing of the valve needle 230 when the injection hole 131 is closed.

The valve needle 230 is formed in the long rod shape in the longitudinal direction. Further, the valve needle 230 conducts the linear reciprocal movement together with the amateur 220 axially, movably mounted on the outer circumferential surface thereof, as the power source of the electromagnetic generator 210 is applied or cut off inside the valve housing 120.

At this time, the amateur 220 is fitted into the valve needle 230 to be coaxial with the valve needle 230.

The valve body 250 is formed in the spherical shape and provided on the end of the engine side of the valve needle 230 and conducts the linear reciprocal movement together with the valve needle 230 to open and close the injection hole 131.

The valve body 250 is provided to close the injection hole 131 when the valve needle 230 moves downward to be seated on the valve seat 130. Further, the valve body 250 is connected to the valve needle 230 through the shock absorption structure and in close contact with the valve seat 130 when the injection hole 131 is closed while the distance with the valve needle 230 is adjusted.

The shock absorption structure is provided between the end of the valve needle 230 and the valve body 250 to support the valve body 250 toward the injection hole 131.

The shock absorption structure is preferably a structure capable of absorbing the shock between the valve needle 230 and the valve body 250. Particularly, the shock absorption structure is provided to be vertically compressible and the valve body 250 is provided to be elastically flowable vertically from the valve needle 230 to absorb the shock.

The shock absorption structure may also include an air cylinder structure, a hydraulic cylinder structure, or the shock absorption spring 240, which is connected between the valve needle 230 and the valve body 250 to support the valve body 250 toward the injection hole 131. A structure in which the shock absorption spring 240 is provided as the shock absorption structure will be described below.

The shock absorption structure includes the shock absorption spring 240 connected between the end of the engine side of the valve needle 230 and the valve body 250 to support the valve body 250 toward the injection hole 131.

The shock absorption spring 240 has the upper end connected to the lower end of the valve needle 230, and the lower end is connected to the valve body 250 to elastically support the valve body 250 toward the valve seat 130.

Particularly, the shock absorption spring 240 absorbs the primary shock amount of the elastic repulsive force generated by the collision of the valve body 250 with the valve seat 130, when the valve body 250 closes the injection hole 131. Further, the shock absorption spring 240 is provided to absorb the secondary shock amount of the elastic repulsive force generated by the collision of the amateur 220 with the positioning 232, and the description thereof will be made later.

The shock absorption structure further includes an accommodation groove 233 to guide the movement of the shock absorption spring 240 and the valve body 250.

The accommodation groove 233 is formed to be longitudinally recessed on the end of the engine side of the valve needle 230 and the shock absorption spring 240 is inserted to guide the movement of the valve body 250.

The accommodation groove 233 is provided to have a cylindrical groove, and the inner diameter of the portion into which the valve body 250 is inserted and which corresponds to the vertically moving location is formed to correspond to the diameter of the valve body 250.

Further, the accommodation groove 233 is formed such that the inner diameter of the bottom surface to which the upper end of the shock absorption spring 240 is fixed has a smaller diameter, and a structure therebetween is formed to be connected by the inclined surface to guide the shock absorption spring 240 and the valve body 250.

Further, the valve needle 230 includes a crimp part 234 for preventing the separation of the valve body 250 from the accommodation groove 233.

The crimp part 234 is formed to protrude from the inner surface of the accommodation groove 233, such that the valve body 250 is seated on the crimp part 234.

The crimp part 234 is formed by inserting the shock absorption spring 240 and the valve body 250 into the accommodation groove 233, and then applying a pressure to any one place of the lower end of the valve needle 230 to protrude to the inside of the accommodation groove 233 to deform the shape. As an example, the crimp part 234 may be formed by being caulked or crimped but is not limited thereto.

Further, the crimp part 234 is formed on two places or more of the lower end of the valve needle 230 to prevent the valve body 250 from being separated from the accommodation groove 233.

At this time, the portion having the largest cross-sectional area of the valve body 250 is disposed to be located inside the accommodation groove 233. That is, the center of the valve body 250 is located inside the accommodation groove 233, such that the valve body 250 is provided to be supported by the crimp part 234 to be vertically movable only inside the accommodation groove 233.

The operation of closing or opening the injection hole 131 of the injector 100 will be described below with reference to FIGS. 8 to 11.

FIGS. 8 to 11 exaggeratively illustrate gaps between the components for helping to understand the operation, and schematically illustrate the valve seat 130 and the injection hole 131. Further, FIGS. 8 to 11 mainly illustrate the pressing spring 201, the stopper 231, the buffer spring 202, the amateur 220, the positioning 232, the valve needle 230, the shock absorption structure, and the valve body 250, which are operating components.

FIG. 8 illustrates the state where the injection hole 131 is opened. Further, this is the state where the power source is applied to the electromagnetic generator 210, such that the valve needle 230 and the amateur 220 move upward while compressing the pressing spring 201 and the buffer spring 202. In this case, the amateur 220 and the positioning 232 are spaced apart from each other and the valve body 250 and the valve seat 130 are spaced apart from each other, such that the fuel is injected toward the engine through the injection hole 131.

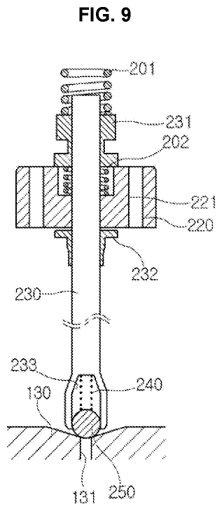

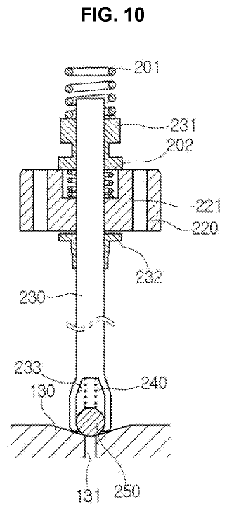

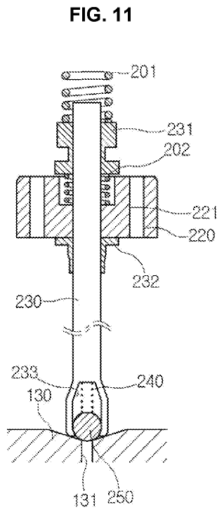

Further, after an amount of the fuel required for the engine is all injected, when the power source of the electromagnetic generator 210 is cut off in order to close the injection hole 131, the operation is completed in the state illustrated in FIG. 11 through the states illustrated in FIGS. 9 and 10.

Referring to FIG. 9, as the power source of the electromagnetic generator 210 is cut off, the amateur 220 and the valve body 250 move downward to be seated on the valve seat 130 together with the valve needle 230 while the pressing spring 201 is restored. At this time, the valve needle 230, the amateur 220, and the valve body 250 move downward by the load and the restoring force of the pressing spring 201 and the valve body 250 and the valve seat 130 collide with each other to generate the primary shock amount.

The primary shock amount is generated between the valve body 250 and the valve seat 130 to be transferrable to the valve needle 230 but absorbed by the shock absorption spring 240 disposed on the middle portion therebetween, thereby fundamentally preventing the bouncing of the valve needle 230.

Thereafter, as illustrated in FIG. 10, the valve needle 230 compresses the shock absorption spring 240 while further moving downward by the restoring force of the pressing spring 201 and the load of the valve needle 230.

At this time, the state illustrated in FIG. 10 maintains the state where the valve body 250 is seated on the valve seat 130 as the shock absorption spring 240 is compressed.

Then, as illustrated in FIG. 11, the amateur 220 moves downward by the restoring force of the buffer spring 202 and the load of the amateur 220 while the buffer spring 202 is restored to collide with the positioning 232 to generate the secondary shock amount.

The secondary shock amount is generated between the amateur 220 and the positioning 232, and transferred to the valve needle 230 integrally provided with the positioning 232 to be transferrable to the valve body 250 and the valve seat 130. However, the shock absorption spring 240 disposed between the valve needle 230 and the valve body 250 absorbs the secondary shock amount, thereby preventing the bouncing, and preventing the separation between the valve body 250 and the valve seat 130.

As described above, the shock absorption spring 240 absorbs the primary shock amount, the downward movement amount of the valve needle 230, and the secondary shock amount, thereby fundamentally preventing the bouncing, and makes the valve body 250 in close contact with the valve seat 130, thereby preventing dribbling.

Describing the operation of opening the injection hole 131 of the injector 100, as illustrated in FIG. 11, when the power source is applied to the electromagnetic generator 210 in the state where the injection hole 131 is closed, as the buffer spring 202 is compressed, the amateur 220 moves upward to become the state of being supported by the stopper 231 illustrated in FIG. 10.

Thereafter, as the pressing spring 201 is compressed, the amateur 220 and the valve needle 230 move upward, and at the same time, the shock absorption spring 240 is restored to become the state illustrated in FIG. 9.

Then, as the pressing spring 201 is further compressed, the amateur 220, the valve needle 230, and the valve body 250 move upward to become the state illustrated in FIG. 8 where the valve body 250 is separated from the valve seat 130, and the injection hole 131 is opened.

Further, FIG. 12 illustrates a part of the injector 100 according to another exemplary embodiment of the present disclosure, and referring to FIG. 12, a hemi-spherical valve body 250 has a location fixing part 253 inserted into the shock absorption spring 240.

The valve body 250 has an opening and closing surface 251 formed to have the hemi-spherical shape and formed to have the curved surface disposed downward, and a seating surface 252, which is formed in the planar shape and on which the shock absorption spring 240 is seated, provided on the opposite side thereof.

Particularly, the seating surface 252 is formed in the planar shape perpendicular to the movement direction of the valve needle 230 such that the shock absorption spring 240 supports the valve body 250 toward the valve seat 130.

Further, the location fixing part 253 formed to protrude from the central portion of the seating surface 252 and inserted into the shock absorption spring 240 is provided.

The location fixing part 253 fixes the location of the shock absorption spring 240 seated on the seating surface 252, and is formed on the central portion of the seating surface 252, such that the shock absorption spring 240 stably supports the valve body 250.

Further, the seating surface 252 forms the crimp part 234 on the lower end of the valve needle 230 in the state of being located inside the accommodation groove 233, thereby preventing the valve body 250 from being separated from the accommodation groove 233.

According to the exemplary embodiments of the present disclosure having such shapes and structures, as the shock absorption structure is provided between the valve needle and the valve body, it is possible to fundamentally prevent bouncing of the valve needle, thereby preventing dribbling or additional injection of undesired fuel toward the engine, and improving combustion performance and exhaust performance, thereby addressing exhaust regulations.

Further, the shock absorption structure absorbs the primary shock amount and the secondary shock amount generated when the injection hole is closed, and the durability and the abrasion resistance are improved even if the coating applied to the conventional valve body is omitted, thereby saving the unit price of the component.

Further, the welding process of the conventional valve needle and valve body is omitted, thereby reducing the number of processes and addressing the manufacturing a manufacturing quality problem such as runout failure due to the welding.

As described above, while all components configuring the exemplary embodiment of the present disclosure have been described as being coupled to one or operated by being coupled, the present disclosure is not necessarily limited to the exemplary embodiment. That is, one or more of all components may also be selectively coupled and operated without departing the target scope of the present disclosure.

The aforementioned description is to merely explain the technical spirit of the present disclosure exemplarily, and those skilled in the art to which the present disclosure pertains may be variously modified and changed without departing from the essential characteristics of the present disclosure. Therefore, the exemplary embodiments disclosed in the present disclosure do not limit the technical spirit of the present disclosure but explain it, and the scope of the technical spirit of the present disclosure is not limited by the exemplary embodiments. The protection scope of the present disclosure should be interpreted by the appended claims, and all technical spirit within its equivalent scope should be interpreted as being included in the claims of the present disclosure.

What is claimed is:

1. An injector for supplying fuel introduced from a fuel rail to an engine, the injector comprising:
a valve needle conducting linear reciprocal movement together with an amateur movably mounted on an outer circumferential surface of the valve needle, as a power source of an electromagnetic generator is applied or cut off inside a valve housing;
a valve body provided on an end of an engine side of the valve needle and conducting the linear reciprocal movement together with the valve needle to open and close an injection hole; and
a shock absorption structure provided between an end of the valve needle and the valve body to support the valve body toward the injection hole.

2. The injector of claim 1, wherein the shock absorption structure comprises:
a shock absorption spring connected between the end of the engine side of the valve needle and the valve body to support the valve body toward the injection hole.

3. The injector of claim 2, wherein the shock absorption structure further comprises:
an accommodation groove formed to be longitudinally recessed on the end of the engine side of the valve needle, the accommodation groove having the shock absorption spring inserted therein, and guiding movement of the valve body.

4. The injector of claim 3, further comprising:
a stopper fixed to a location for facing a fuel rail side of the amateur on the valve needle;
a positioning fixed to a location for facing the engine side of the amateur on the valve needle;
a pressing spring installed in the valve housing to press the valve needle toward the injection hole; and
a buffer spring provided between the stopper and the amateur on the valve needle to press the amateur toward the positioning.

5. The injector of claim 4, wherein when the injection hole is closed, the shock absorption spring is coupled to cover the end of the engine side of the valve housing, and absorbs a primary shock amount generated by a collision of the valve body with a valve seat formed with the injection hole and absorbs a secondary shock amount generated by a collision of the amateur with the positioning.

6. The injector of claim 3, wherein the valve needle comprises:
a crimp part formed to protrude from an inner surface of the accommodation groove to seat the valve body and preventing the valve body from being separated from the accommodation groove.

7. The injector of claim 2, wherein the valve body comprises:
a seating surface formed in a planar shape perpendicular to a movement direction of the valve needle to seat the shock absorption spring; and
a location fixing part formed to protrude from a central portion of the seating surface and inserted into the shock absorption spring.
